(19) United States
(12) Patent Application Publication
(10) Pub. No.: US 2010/0088427 A1
(43) Pub. Date: Apr. 8, 2010

(54) Selective Routing of Data Transmission Between Clients

(75) Inventors: Jianxiang Mo, Hangzhou (CN); Zhenguo Bai, Hangzhou (CN)

Correspondence Address: LEE & HAYES, PLLC, 601 W. RIVERSIDE AVENUE, SUITE 1400, SPOKANE, WA, 99201, US

(73) Assignee: Alibaba Group Holding Limited

(21) Appl. No.: 12/598,856

(22) PCT Filed: Nov. 6, 2008
(86) PCT No.: PCT/US08/82567

§ 371 Date: Nov. 4, 2009

(30) Foreign Application Priority Data
Nov. 6, 2007 (CN) 200710168112.8

(51) Int. Cl. G06F 15/173

(52) U.S. Cl. 709/241

(57) ABSTRACT

A method for selective routing of data transmission between clients is provided to select a better communication channel from a direct P2P channel and a relay channel according to routing hop counts of the pats. The method obtains a first routing hop count from a first client to a second client assuming a direct P2P channel therebetween, a second routing hop count from the first client to a relay server assuming a relay channel through the relay server, and a third routing hop count from the relay server two the second client assuming the relay channel through the relay server, and compares the sum of the second routing hop count and the third routing hop count with the first routing hop count. The method then selects a better data transmission channel from the direct P2P channel and the relay channel between the first client and the second client based on a comparison result. Also disclosed is a system using the method for selective routing.

### RELATED APPLICATIONS

The present application claims priority benefit of Chinese patent application No. 200710168112.8, filed Nov. 6, 2007, entitled “SYSTEM AND APPARATUS SELECTIVE ROUTING OF DATA TRANSMISSION BETWEEN CLIENTS”, which Chinese application is hereby incorporated in its entirety by reference.

### BACKGROUND ART

The present disclosure relates to the network communication, and particularly to the technologies of routing analysis for setting up a data transmission mode or channel.

Along with the current widespread use of Internet technologies, communication applications over the network have become increasingly important for people's work, education and entertainment. In particular, data exchange between clients has greatly facilitated file sharing and exchange of audios and videos between network users. In general, there are two types of methods for data exchange between clients. The first type uses direct P2P (Peer-to-Peer) technology to establish a P2P transmission channel to transmit data files. The P2P technology referred to here is not the same as the similar technologies that are server-based. It is a relatively new network communication technology based upon topological structures of a P2P network. If methods of providing Internet services are categorized into three types, namely Server-based, with-Server (partly based on server) and non-Server, the P2P technology may mainly belong to with-Server and non-Server categories.

The second type uses a relay server designated for file transmission to establish a relay transmission channel. When both initiating client and responding client connect to the relay server, data file begins to transmit.

Using the direct P2P method to transmit data, high speed data transmission may be achieved when the routing hop count between the two communicating clients is small. The routing hop count is the number of jumps a data packet needed to traverse from one router level, usually a source router, to another router level, usually a destination router. Examples that satisfy this condition are communications between ADSL (Asymmetrical Digital Subscriber Loop) network users of the same ISP (Internet Service Provider), and between users residing in the same LAN (Local Area Network). This type of direct P2P method does not occupy network bandwidth of a network service carrier and has low operation cost. However, under certain networked environments, it may not be able to establish a direct P2P transmission channel for data exchange. One example is when both clients of data exchange are in different LANs which are both symmetric NAT (Network Address Translation) types. Besides, even when a direct P2P transmission channel may be established in some networked environments, setting up the direct P2P channel may require a higher routing hop count because the networks where the communicating clients reside belong to different ISPs. Due to longer delays in the network and restrictions on the bandwidth of intermediate link, the speed of data transmission is very slow.

Nevertheless, a network service carrier may use a relay server to establish a relay transmission channel, buy bandwidth from ISP, and perform route optimization to raise the speed of transmission between clients performing file transmission to a certain acceptable level. But compared with a direct P2P transmission channel built between users in the same LAN, the speed may still be slower. Moreover, the operation cost for the network service carrier is higher this way.

In existing technologies, when a data transmission is performed between clients, the use of direct P2P channels for transmission is usually maximized in order to reduce the operation cost of the network service carrier. However, it is clear from the brief introduction of the direct P2P technology described above that, under certain networked environments (for instance, both clients of data transmission belong to different ISPs), even though users may establish a direct P2P transmission channel for data transmission, the transmission speed can be very slow. As a result, especially when a large volume of file is transmitted, the data transmission takes a long time and results in poor user experience.

### SUMMARY

In order to solve the deficiencies observed in data transmission between clients in existing technologies, the present disclosure provides a method and a system for selective routing of data transmission between clients. The method selects a better communication mode or channel from direct P2P link and relay link according to routing hop counts.

According to one aspect of the disclosure, the method for selective routing of data transmission between clients is used in a network system which includes at least a first client, a second client, a central server and a relay server. The method is to obtain three routing hop counts, namely a first routing hop count from the first client to the second client assuming using a direct P2P link therebetween, a second routing hop count from the first client to the relay server assuming a relay channel through the relay server, and a third routing hop count from the second client to the relay server assuming a relay channel through the relay server. The method compares the sum of the second routing hop count and the third routing hop count with the first routing hop count, and then selects a data transmission method from a direct P2P method and a relay method between the first client and the second client, based on a comparison result. In one embodiment, a relay method is selected to transmit data between the first client and the second client if the sum of the second routing hop count and the third routing hop count is smaller than the first routing hop count, and a P2P link method is selected to transmit data between the first client and the second client if the sum of the second routing hop count and the third routing hop count is greater than the first routing hop count.

In one embodiment, the first client obtains the first routing hop count and the second routing hop count. The second client obtains the third routing hop count.

According to one embodiment, if direct P2P method is selected according to the above criteria, but a direct P2P transmission channel cannot be established when the direct P2P method is used, a relay transmission channel using the relay method is then chosen for carrying out data transmission.

In one embodiment, the first client obtains a network address of the second client and an address of the relay server through the central server and uses a route detection interface to obtain the first and the second routing hop counts, respectively. More specifically, the network address of the second client is used by a route detection interface as an address parameter to generate the first routing hop count. Likewise, the address of the relay server is used by the route detection interface as an address parameter to produce the second routing hop count.

In another embodiment, the second client obtains the address of the relay server through the central server and uses a route detection interface to obtain the third routing hop count. More specifically, the second client receives a request command from the first client through the central server, parses the request command to obtain the address of the relay server contained therein, and provides the address of the relay server as an address parameter to the route detection interface to obtain the third routing hop count.

According to another aspect of the current disclosure, the disclosure provides a routing system for selective routing of data transmission between clients in a network. The routing system includes route analysis means for obtaining the first, the second and the third routing hop counts, and a determination module for comparing the sum of the second routing hop count and the third routing hop count with the first routing hop count. Based on the comparison result, we determination module selects a preferred transmission method from a direct P2P link method and a relay method for data transmission between the first client and the second client.

Using the disclosed method and the system for selective routing of data transmission between clients, if a P2P transmission channel can be established and the routing hop count using the direct P2P is smaller than the routing hop count using the relay method of the relay server, the direct P2P transmission method is selected for data transmission. If the direct P2P transmission channel can be established but the routing hop count using the direct P2P is greater than the routing hop count using the relay method of the relay server, a relay transmission channel through using the relay server is chosen for data transmission instead. As such, data exchange between clients may have high speed transmission under various networked environments to greatly improve the user experience.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a flow chart of an existing method for data transmission between clients.

FIG. 2 shows a schematic diagram of an exemplary method for selective routing of data transmission between clients in accordance with the present disclosure.

FIG. 3 shows a flow chart of an exemplary method for selective routing of data transmission between clients in accordance with the present disclosure.

FIG. 4 is a flow chart of an exemplary process of obtaining routing hop counts by an initiating client.

FIG. 5 is a flow chart of an exemplary process of obtaining a routing hop count by a responding client.

FIG. 6 shows a schematic diagram of a system for selective routing of data transmission between clients in accordance with the present disclosure.

FIG. 7 shows a schematic diagram of an exemplary network system which uses the selective routing of data transmission between clients in accordance with the present disclosure.

### DETAILED DESCRIPTION

In the following, exemplary embodiments are described in further details with reference to figures. For the purpose of illustration, a method according to the existing techniques is first described.

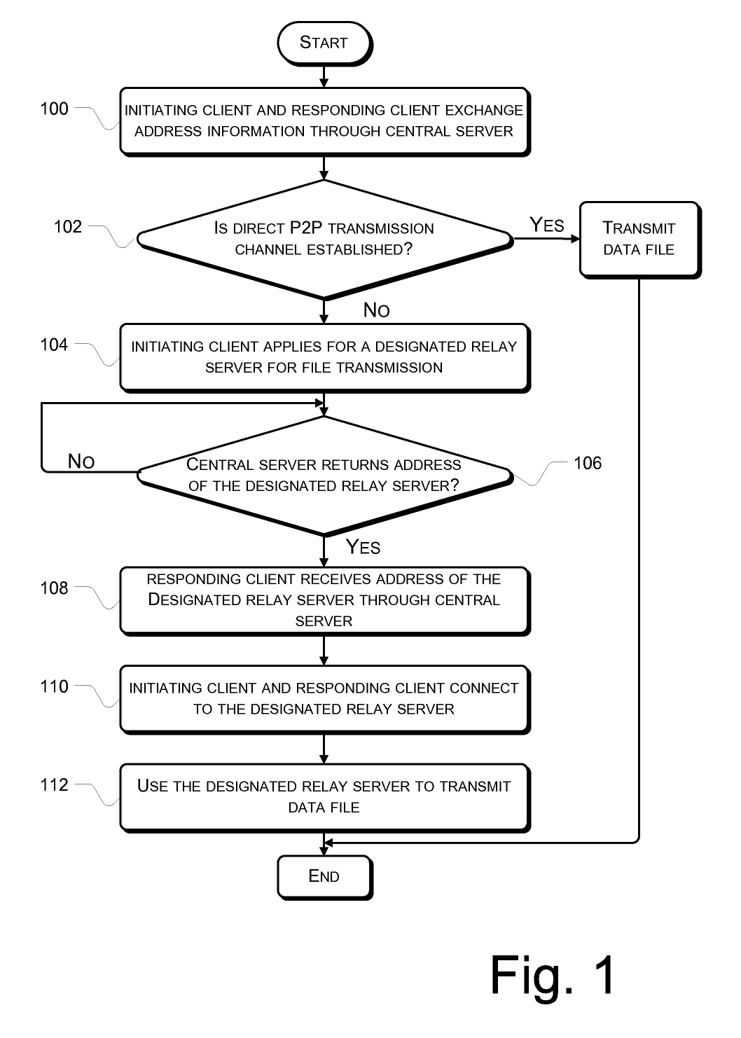

FIG. 1 shows a flow chart of a method for data transmission between clients according to the existing technologies. File transmission in an instant messaging system is used as an example to illustrate the general principles. Without loss of generality, the end that initiates the file transmission is referred to as initiating client, while the end that responds to the initiating client for file transmission is referred to as responding client. To start, the initiating client and the responding client exchange address information for direct communication through a central server, and try to establish a direct P2P transmission channel. If the direct P2P transmission channel is successfully established, the direct P2P transmission channel is used for data file transmission. If the direct P2P transmission channel cannot be established, the initiating client applies for a designated relay server through the central server. After the central server has returned an address of the relay server to be used for data file transmission, the initiating client sends the address of the relay server to the responding client through the central server. The initiating client and the responding client then connect to the relay server based on the address of the relay server. Once a relay transmission channel is established, the initiating client and the responding client can use the relay transmission channel for data file transmission. More intuitively, the existing method of data transmission can be implemented by the following process:

At block 100, initiating client and responding client exchange address information through a central server.

At block 102, initiating client and responding client attempt to establish a direct P2P transmission channel and determine whether the channel is successfully established. If the direct transmission channel is set up successfully, a data file begins to be transmitted.

At block 104, if the direct P2P transmission channel cannot be established between the initiating client and the responding client, the initiating client applies for a designated relay server for file transmission.

At block 106, after the central server returns an address of the designated relay server, the initiating client sends the address to the responding client through the central server.

At block 108, the responding client receives the address of the relay server through the central server.

At block 110, the initiating client and the responding client connect to the designated relay server based on the address of the relay server, and establish a relay transmission channel.

At block 112, the data file is transmitted through the relay transmission channel.

As illustrated above, in existing technologies, to transmit data between clients, an attempt using the direct P2P method is initially made to establish a transmission channel. Only when the setting up of the transmission channel using the direct P2P method fails does the initiating client apply for a designated relay server to transmit the file. This may be disadvantageous because as previously discussed, Although maximizing the use of the direct P2P method to transmit files can reduce operation cost for a carrier, using the direct P2P method may lead to a very slow transmission speed and poor user experience for users under various networked environments.

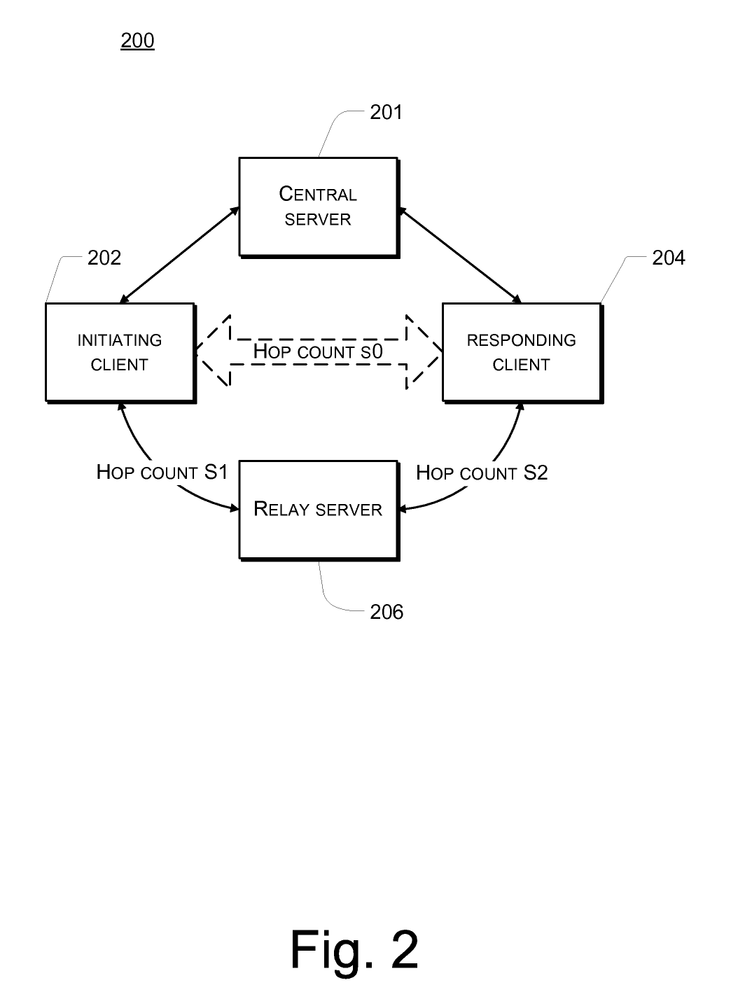

FIG. 2 shows a schematic diagram of an exemplary method for selective routing of data transmission between clients in accordance with the present disclosure. The disclosed method provides selective routing of data transmission between clients by selecting a better suited data transmission channel between the clients after comparing the routing hop count obtained assuming the direct P2P method and the routing hop count assuming the relay method using a designated relay server. This solves the problem that under certain networked environments, using the direct P2P method for data transmission may not result in the fastest transmission speed.

A process of selecting a data transmission channel in FIG. 2 involves a network system 200 which mainly includes a central server 201, an initiating client 202, a responding client 204 and a relay server 206. Preferably, the relay server 206 is a designated relay server that is to be assigned to the initiating client 202 if the initiating client 202 applies for a designated relay server for establishing a relay transmission channel. Through interactions with the central server 201, the initiating client 202 obtains a network address (such as a NAT address) of the responding client 204 and an address of the relay server 206, while the responding client 204 obtains the address of the relay server 206. The initiating client 202 then uses a route detection interface in its function modules and the address information to generate routing hop counts. Specifically, the route detection interface uses the NAT address of the responding client 204 and the address of the relay server 206 as address parameters to be sent to generate a routing hop count S0 which is counted from the initiating client 202 and the responding client 204, and a routing hop count S1 which is counted from the initiating client 202 to the relay server 206, respectively. The routing hop count SO is the routing hop count from the initiating client 202 to the responding client 204 if direct P2P communication is used to transmit data that between, while the routing hop count S1 is the routing hop count from the initiating client 202 to the relay server 204 if a relay method using the relay server 204 is used to transmit data between the initiating client 202 and the responding client 204.

The responding client 204 then uses a route detection interface in its function modules to generate a routing hop count S2 from the relay server 206 to the responding client 204. To do this, the route detection interface uses the address of the relay server 206 as an address parameter to be sent. The sum of the routing hop count S1 and the routing hop count S2 represents the total routing hop and from the initiating client 202 and the responding client 204 if a relay method using the relay server 206 is used to transmit data.

After this, the routing hop count SO is compared with the sum of the routing hop counts S1 and S2. If the routing hop count SO obtained assuming using the direct P2P method is greater than the sum of the routing hop counts S1 and S2 obtained assuming using the relay method, the relay method based on the designated relay server 206 appears to be a better choice, and is therefore selected for data transmission between the initiating client 202 and the responding client 204. If the routing hop count SO obtained assuming using the direct P2P method is smaller than the sum of the routing hop counts S1 and S2 obtained assuming using the relay method, the direct P2P method appears to be a superior choice, and is therefore selected for data transmission between the initiating client 202 and the responding client 204 (shown as a dotted arrow line in FIG. 2).

In one embodiment, in case where a direct P2P transmission channel cannot be established when the direct P2P method is selected, the relay server 206 is used to establish a relay transmission channel to complete data transmission.

As a result, in the disclosed method for selective routing of data transmission between clients, if a direct P2P transmission channel can be established, the direct P2P method is preferably used for transmission under a networked environment where the transmission speed using the direct P2P method is likely to be faster than the transmission speed using the relay method. If the direct P2P transmission channel can be established but the transmission speed using the direct P2P method is likely to be slower than the transmission speed using the relay method under that networked environment, the relay method is preferably used for transmission. A person of ordinary skills in art should readily understand that the speed of transmission is mainly but not exclusively manifested by the size of the routing hop count. Given the same network bandwidth conditions, a transmission channel of a higher routing hop count generally has a lower transmission speed, while a transmission channel of a smaller routing hop count generally has a higher transmission speed.

The network address of a client (e.g., the responding client 204) is preferably its NAT (Network Address Translation) address. The NAT address is a standard method of mapping one address field (such as Intranet) to another address field (such as Internet). NAT allows a host machine in a designated Intranet of an organization transparently connect to a host machine in the public domain without the need of a registered Internet address for the local (inside) host machine. In other words, a local (or private) network can register an IP (Internet Protocol) address through the Internet to connect to the external world. Before sending a data packet, a NAT router, which acts as an agent between internal (private or local) and external (public) networks, is responsible to convert a local IP address to a public IP address. Herein, the NAT address of a client refers to the public IP address translated from a local IP address of the client. A server (e.g., the relay server 206) generally has its own public IP address and requires no NAT translation. However, if necessary, a NAT address of the relay server 206 may also be used.

In order to describe more clearly the method of selective routing of data transmission between clients in this disclosure, an exemplary process is described below. In this description, the order in which a process is described is not intended to be construed as a limitation, and any number of the described process blocks may be combined in any order to implement the method, or an alternate method.

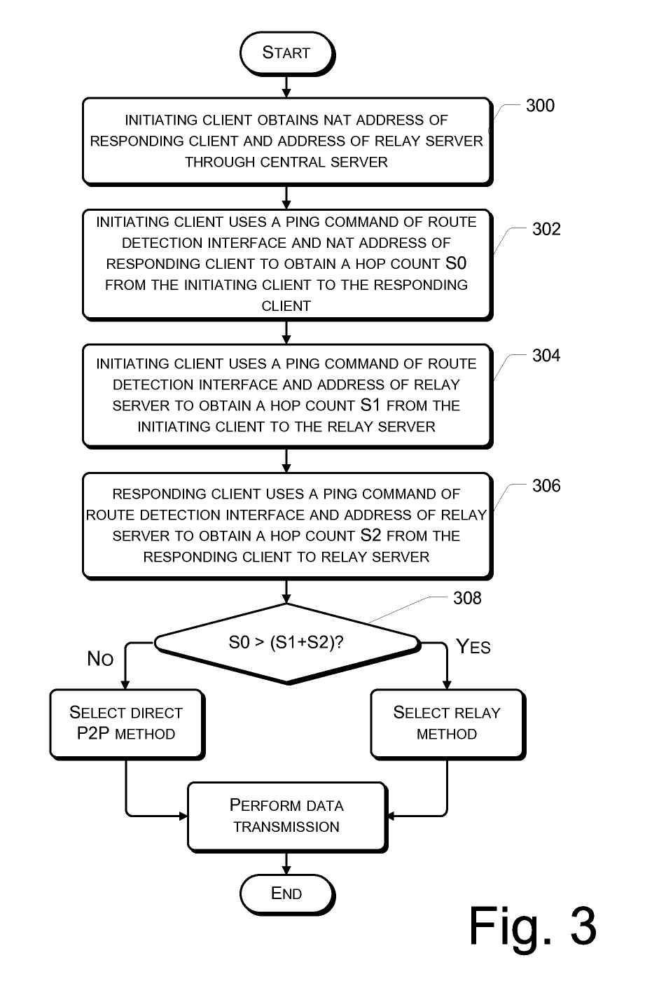

FIG. 3 shows a flow chart of an exemplary process for selective routing of data transmission between clients. The process is described as follows.

At block 300, initiating client 202 obtains a NAT address of a responding client 204 and an address of a relay server 206.

At block 302, the initiating client 202 uses a route detection interface of a function module and uses its Ping command and the NAT address of the responding client 204 to obtain a routing hop count S0 for direct P2P link between the initiating client 202 and the responding client 204.

At block 304, the initiating client 202 uses the route detection interface of the function module and uses its Ping command and the address of the relay server 206 to obtain a routing hop count S1 from the initiating client 202 to the relay server 206.

At block 306, the responding client 204 uses a route detection interface of a function module, and its Ping command and the address of the relay server 206 to obtain a routing hop count S2 from the responding client 204 to the relay server 206.

At block 308, the routing hop count S0 is compared with the sum (S1+S2). If SO is smaller than (S1+S2), the direct P2P method is preferably used to establish a transmission channel for data file transmission. If S0 is greater than (S1+S2), the relay method is preferably used to establish a relay transmission channel for data file transmission.

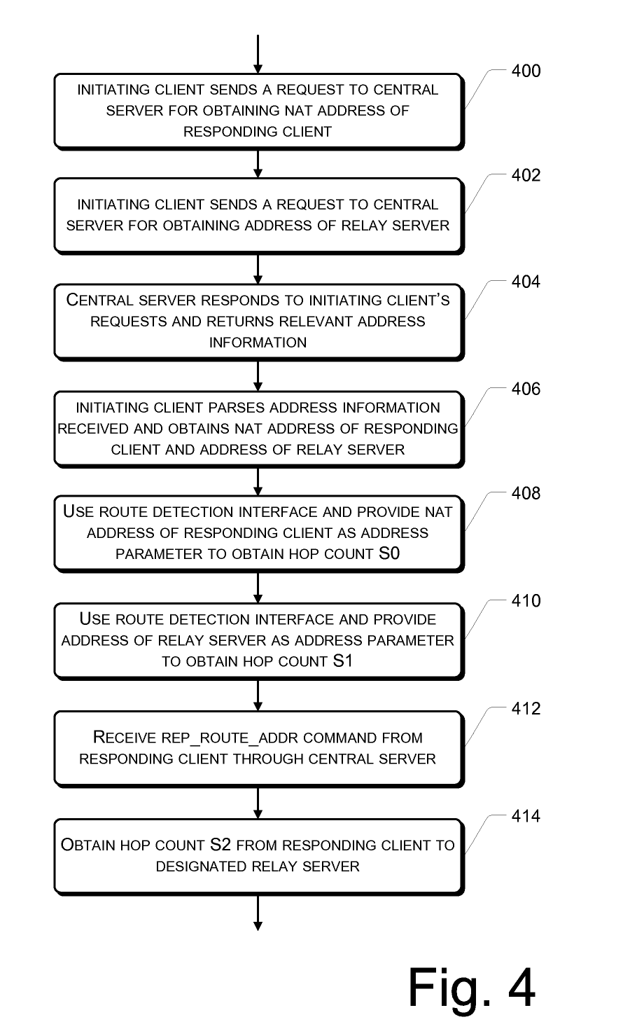

FIG. 4 is a flow chart of an exemplary process showing how the initiating client 202 obtains routing hop counts S0 and S1 introduced in FIG. 3. In FIG. 4, a core of the process of obtaining the routing hop counts S0 and S1 by the initiating client 202 is the process for the initiating client 202 to obtain the NAT address of the responding client 204 and the address of the relay server 206. According to one or more aspects of this disclosure, the following procedure may be used:

At block 400, the initiating client 202 sends a request for obtaining a NAT address of the responding client 204 to the central server 201.

At block 402, the initiating client 202 sends a request for obtaining an address of a designated relay server 206 to the central server 201.

At block 404, the central server 201 responds to the requests of the initiating client 202 and returns relevant address information from which the requested addresses of the responding client 204 and the relay server 206 may be extracted or parsed.

At block 406, the initiating client 202 parses the address information received to obtain the NAT address of the responding client 204 and the address of the relay server 206.

At block 408, the initiating client 202 uses a route detection interface with the NAT address of the responding client 204 as an address parameter to obtain routing hop count S0.

At block 410, the initiating client 202 uses the route detection interface with the address of the relay server 206 as the address parameter to obtain routing hop count S1.

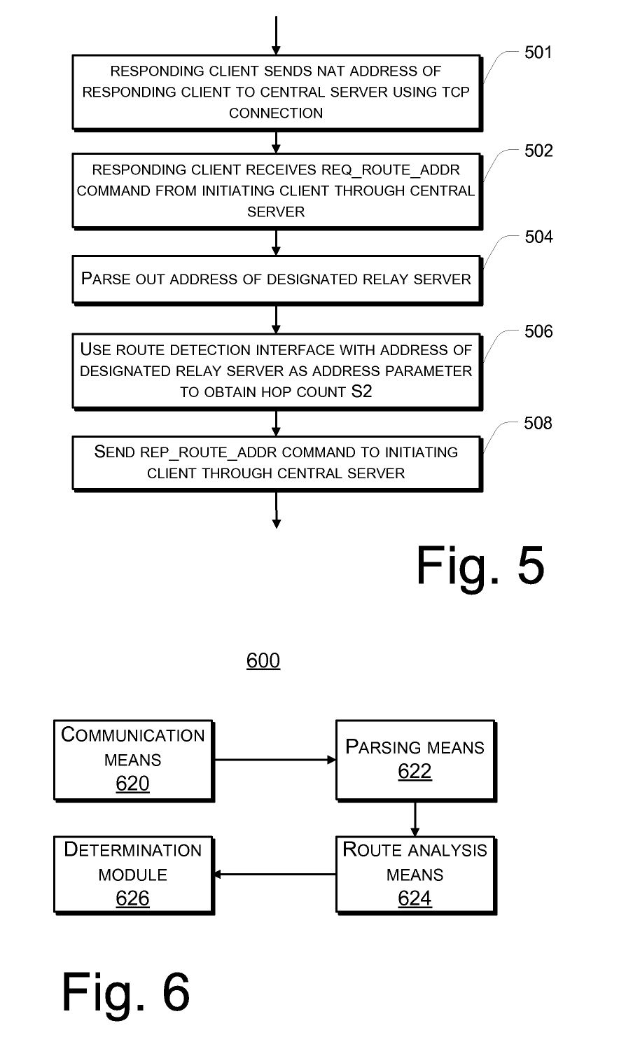

At block 412, the initiating client 202 receives a command (e.g., a command REP_ROUTE_ADDR) from the responding client 204 through the central server 201. Assuming the responding client 204 has obtained routing hop count S2 at this point, the command may include information such as the routing hop count S2. The process of obtaining the routing hop count S2 by the responding client 204 is described subsequently herein with reference to FIG. 5.

The command sent by the responding client 204 may be a reply command in response to a request command received from the initiating client 202. The request command from the initiating client 202 may request, either explicitly or impliedly, for route information such as the routing hop count S2. In one embodiment, the request command is sent along with address information from which the responding client 204 may parse the address of the relay server 206 and use it for obtaining the routing hop count S2. In this particular configuration, receiving the request command from the initiating client 202 would need to precede block 412.

At block 414, the initiating client 202 parses the request command the attached information and obtains the routing hop count S2.

FIG. 5 is a flow chart showing how the responding client 204 obtains routing hop count S2 as introduced in FIG. 3. In FIG. 5, the core of the process of obtaining the routing hop count S2 by the responding client 204 is the process of the responding client 204 obtaining the address of the relay server 206. In one embodiment, the initiating client 202 sends a command (such as a request command REQ_ROUTE_ADDR) to the responding client 204 through the central server 201. The command may contain the address of the relay server 206. Upon receiving the command through the central server 201, the responding client 204 obtains the address of the relay server 206 and uses a route detection interface of a function module to obtain the routing hop count S2. An exemplary process is described as follows.

At block 501, the responding client 204 sends the NAT address of the responding client 204 to the central server 201 using, for example, a TCP connection. In a separate process as shown in FIGS. 3-4, the NAT address of the responding client 204 may be then sent to the initiating client 202 upon request.

At block 502, the responding client 204 receives a REQ_ROUTE_ADDR command from an initiating client 202 through the central server 201.

At block 504, the responding client 204 parses out an address of the relay server 206 from the received command. The relay server 206 is a designated relay server assigned to the initiating client 202 upon request.

At block 506, the responding client 204 uses a route detection interface with the address of the relay server 206 as an address parameter to obtain the routing hop count S2 by Ping command.

At block 508, the responding client 204 sends a REP_ROUTE_ADDR command to the initiating client 202 through the central server 201. The command may contain the routing hop count S2 which is counted from the relay server 206 to the responding client 204. This command may be sent in response to a previous command received from the initiating client 202 sending and/or requesting address and route information, as described with reference to FIG. 4.

The above FIG. 4 illustrates an exemplary method for obtaining the routing hop count S0 (counted from the initiating client 202 to the responding client 204 using the direct P2P method) and the routing hop count S1 (counted from the initiating client 202 to the relay server 206) at the initiating client 202. FIG. 5 illustrates an exemplary method for obtaining the routing hop count S2 (counted from the relay server 206 to the responding client 204) at the responding client. When combined, FIG. 4 and FIG. 5 show an exemplary method for selective routing of data transmission between clients. The method performs a route analysis and detection for available data transmission channels and uses a comparison result of the routing hop counts (S0, S1 and S2) to determine whether the direct P2P transmission method should be used for setting up a data transmission channel. This is different from the existing technologies which always attempt to use the direct P2P transmission method to establish a transmission channel first. The disclosed method allows users to achieve an optimal speed for data transmission between clients under various networked environments. Specifically, if a P2P transmission channel can be established, and the routing hop count (S0) using the direct P2P is smaller than the routing hop count (51 +S2) using the relay method of a relay server, the direct P2P transmission is selected for data transmission. If the direct P2P transmission channel can be established, but the routing hop count using the direct P2P is greater than the routing hop count using the relay method of the relay server, a transmission channel established through a relay method using a relay server is chosen for data transmission instead. This design may greatly improve user experience.

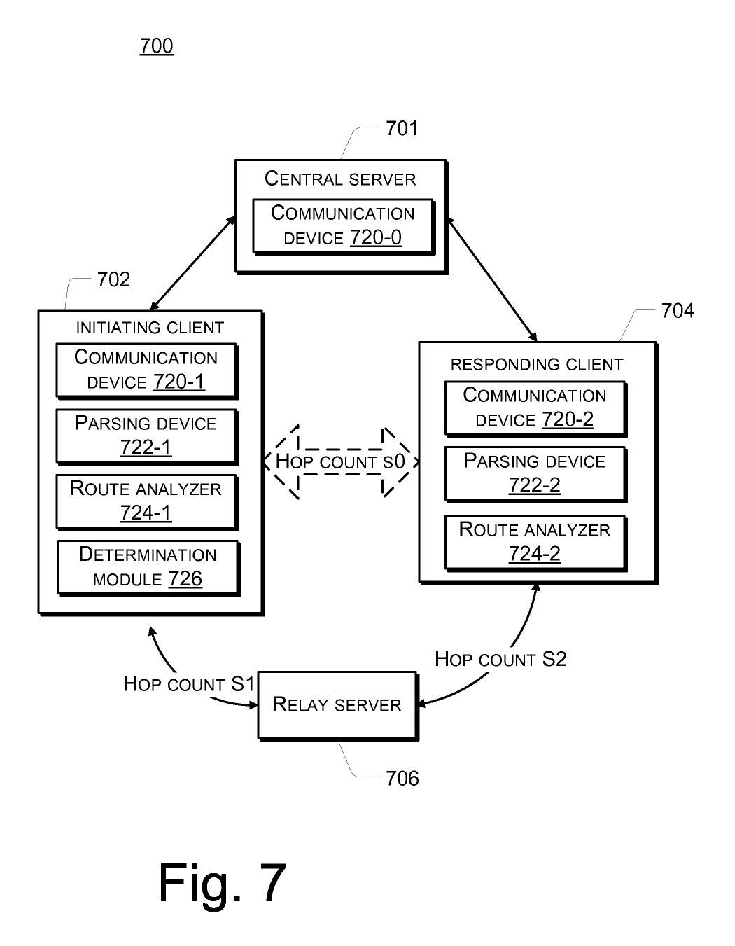

The acts of the above-described process may be performed by various parts of the system such as the system 200 of FIG. 2, and the systems shown below with reference to FIGS. 6-7.

FIG. 6 is a schematic representation of a system for implementing the method for selective routing of data transmission between clients. System 600 includes communication means 620 for communicating information between clients and servers; parsing means 622 for extracting information from the communicated data; route analysis means 624 for determining route hop counts of the available data transmission channels; and determination module 626 to compare the route hop counts and use the comparison result to select a preferred data transmission channel.

In one embodiment, communication means 620 represents communication device(s) used for sending and receiving between an initiating client and a central server address information containing a network address of a responding client and an address of a relay server. Communication means 620 also represents communication device(s) for sending and receiving routing commands and address information containing the address of the relay server between the responding client and the initiating client (through the central server). The parsing means 622 represents parsing device(s) used for parsing out the network address of the responding client and the address of the relay server from the address information sent from the central server. The parsing means 622 also represents parsing device(s) for parsing out the address of the relay server from the address information sent from the initiating client. Route analysis means 624 represents device(s) for obtaining, based on the network address of the responding client, a first routing hop count counted from the initiating client and the responding client, and for obtaining based on the address of the relay server a second routing hop count counted from the initiating client and the relay server. Route analysis means 624 also represents device(s) for obtaining based on the address of the relay server a third routing hop count counted from the relay server to the responding client. The determination module 626 is for comparing the routing hop counts, e.g., checking if a sum of the second routing hop count and the third routing hop count is greater than the first routing hop count. The determination module 626 selects one from direct P2P link method and the relay method for data transmission depending on the comparison result.

Any suitable means may be used to deploy the communication means 620, parsing means 622, route analysis means 624, and determination module 626. The means and devices that perform the selective routing process may be embodied in the various components (e.g., initiating client 202, responding client 204, central server 200, and relay server 206) of a selective routing system, as illustrated further below.

Implementation Environment

FIG. 7 shows a schematic diagram of an exemplary network system which uses the selective routing of data transmission between clients in accordance with the present disclosure. The network system 700 represents an exemplary implementation environment of the method for selective routing of data transmission between clients described above with reference to FIGS. 3-5 and the selective routing system 600 of FIG. 6. The network system 700 includes central server 701, initiating client 702, responding client 704 and relay server 706.

Communication means 620 as described in FIG. 6 is embodied in communication devices 720-0, 720-2 and 720-2. In the exemplary embodiment illustrated in FIG. 7, communication device 720-0 is either part of the central server 701 or a separate device connected to the central server 701; communication device 720-1 is either part of the initiating client 702 or a separate device connected thereto; and communication device 720-2 is either part of the responding client 704 or a separate device connected thereto.

Communication device 720-1 sends a request for the network address of the responding client 704 and the address of the relay server 706 to communication device 720-0, which in turn returns the requested address information to communication device 720-1. Likewise, communication device 720-2 sends a request for the address of the relay server 706 to communication device 720-0, which in turn returns the requested address information to communication device 720-2. Communication devices 720-0, 720-1 and 720-2 are also used for sending and receiving routing commands and address information (e.g., which contains the address of the relay server 706) between the initiating client 702 and the responding client 704, through the central server 701. For example, communication device 720-1 may send a route information request command REQ_ROUTE_ADDR to the responding client 704 through communication device 720-2 to request information of the routing hop count S2 counted from the relay server 706 to the responding client 704. Communication device 720-1 may also send the address of the relay server 706, preferably along with the route information request command, to communication device 720-2 in order to facilitate the determination of the routing hop count S0 by the route adviser 724-2 at the responding client 704, as described herein. In turn, communication device 720-2 returns the determined routing hop count S2 with a reply command REP_ROUTE_ADDR to the initiating client 702 (preferably through the central server 701) using the communication device 720-1.

Parsing means 622 as described in FIG. 6 is embodied in parsing devices 722-1 and 722-2. The parsing device 722-1 is either part of the initiating client 702 or a separate device connected thereto; and the parsing device 722-2 is either part of the responding client 704 or a separate device connected thereto. The parsing device 722-1 parses out the network address of the responding client 704 and the address of the relay server 706 from the address information sent from the communication device 720-0 at the central server 701. The parsing device 722-2 parses out the address of the relay server 706 from the address information sent from the initiating client 702.

Route analysis means 624 of FIG. 6 is embodied in route analyzers 724-1 and 724-2. The route analyzer 724-1 is either part of the initiating client 702 or a separate device connected thereto. The route analyzer 724-2 is either part of the responding client 704 and a separate device connected thereto. The route analyzer 724-1 obtains the first routing hop count S0 counted from the initiating client 702 and the responding client 704 based on the network address of the responding client 704. The route analyzer 724-1 also obtains the second routing hop count S1 counted from the initiating client 702 and the relay server 706 based on the network address. The route analyzer 724-2 obtains the third routing hop count S2 counted from the relay server 706 to the responding client 704 based on the address of the relay server 706.

Determination module 626 of FIG. 6 is embodied in determination module 726, which is either part of the initiating client 702 or a separate device connected thereto. The determination module 726 compares a sum of the second routing hop count S1 and the third routing hop count S2 with the first routing hop count SO. The determination module 726 then selects a preferred data transmission channel or mode (from, e.g., a direct P2P link method or a relay method) based on the comparison result, as illustrated herein.

In the above-described embodiment, given the illustrated locations of route analyzers 724-1 and 724-2, the processes of obtaining the first routing hop count S0 and obtaining the second routing hop count S1 may be both initiated and at least partially performed by the initiating client 702, while the process of obtaining the third routing hop count S2 may be initiated and at least partially performed by the responding client 704. However, it is appreciated that the route analyzing means 624 of FIG. 6 may be embodied in a common route analyzer outside the initiating client 702 and the responding client 704, as long as the common route analyzer is accessible to the initiating client 702 and the responding client 704. The common route analyzer may be configured to perform the functions of both route analyzer 724-1 and 722-2. For example, the common analyzer may be either part of the central server or connected thereto. Likewise, the determination module 726 may be located at the central server 701 instead of at the initiating client 702 as illustrated in FIG. 7. In this case, the third routing hop count S2, after being determined by route analyzer 724-2, may be sent to the central server 702 where the determination module is located, and not to the initiating client 702.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for selective routing of data transmission between clients in a network system including a first client, a second client, a central server and a relay server, the method comprising:
obtaining a first routing hop count from the first client to the second client assuming a direct P2P link therebetween;
obtaining a second routing hop count from the first client to the relay server assuming a relay channel through the relay server;
obtaining a third routing hop count from the relay server to the second client to assuming the relay channel through the relay server;
comparing a sum of the second routing hop count and the third routing hop count with the first routing hop count; and
selecting one of the direct P2P link and the relay channel as a data transmission channel between the first client and the second client based on a result of comparing.

2. The method as recited in claim 1, wherein selecting the data transmission channel comprises:
selecting a relay method to transmit data between the first client and the second client if the sum of the second routing hop count and the third routing hop count is smaller than the first routing hop count; and
selecting a P2P link method to transmit data between the first client and the second client if the sum of the second routing hop count and the third routing hop count is greater than the first routing hop count.

3. The method as recited in claim 2, wherein selecting the data transmission channel further comprises:
selecting the relay method to transmit data between the first client and the second client if the P2P link method is first selected, but a direct P2P transmission channel cannot be established.

4. The method as recited in claim 1, wherein obtaining the first routing hop count and obtaining the second routing hop count are both initiated and at least partially performed by the first client.

5. The method as recited in claim 1, wherein obtaining the first routing hop count comprises:
obtaining by the first client a network address of the second client; and
obtaining the first routing hop count using a route detection interface based on the network address of the second client.

6. The method as recited in claim 5, wherein obtaining the first routing hop count using the route detection interface comprises:
sending by the route detection interface a PING command which has the network address of the second client as an address parameter to generate the first routing hop count.

7. The method as recited in claim 1, wherein obtaining the second routing hop count comprises:
obtaining by the first client an address of the relay server; and
obtaining the second routing hop count using a route detection interface based on the address of the relay server.

8. The method as recited in claim 1, wherein the third routing hop count is obtained by the second client, and the method further comprises:
sending the third routing hop count to the first client or the central server for routing hop count comparison.

9. The method as recited in claim 1, wherein the third routing hop count is obtained by the second client, and the method further comprises:
receiving by the second client from the first client a request command for route information; and
in response to the request command, sending the third routing hop count to the first client for routing hop count comparison.

10. The method as recited in claim 9, wherein the request command is sent along with an address information from which an address of the relay server can be parsed.

11. A routing system for selective routing of data transmission between clients in a network, the routing system comprising:
route analysis means for obtaining a first routing hop count, a second routing hop count and the third routing hop count, the first routing hop count being counted from a first client to a second client assuming a direct P2P link therebetween; the second routing hop being counted from the first client and a relay server assuming a relay channel through the relay server, and the third routing hop count being counted from the relay server two the second client assuming the relay channel through the relay server; and
a determination module for comparing a sum of the second routing hop count and the third routing hop count with the first routing hop count, and selecting one of the direct P2P link and the relay channel as a data transmission channel between the first client and the second client based on a result of comparing.

12. The routing system as recited in claim 11, the system further comprising:
a communication unit for receiving from the first client a request for a network address of the second client and an address of the relay server, and for sending the network address of the second client and the address of the relay server to the first client.

13. The routing system as recited in claim 12, wherein the communication unit resides in a central server.

14. The routing system as recited in claim 11, the system further comprising:
a communication unit for sending an address of the relay server to the second client, and at least a part of the route analysis means resides in the second client for obtaining the third routing hop count based on the address of the relay server.

15. The routing system as recited in claim 14, wherein the communication unit resides in the first client.

16. The routing system as recited in claim 14, wherein the communication unit is further used for sending to the second client a request for route information including the third routing hop count.

17. The routing system as recited in claim 16, wherein the address of the relay server is sent to the second client along with the request for route information.

18. A routing system for selective routing of data transmission between clients in a network system including least a first client, a second client, a central server and a relay server, wherein the routing system comprises:
a first communication device residing at the central server for sending a network address of the second client and an address of the relay server to the first client;
a second communication device residing at the first client for receiving the network address of the second client and the address of the relay server sent by the first communication device;
a third communication device residing at the second client for receiving a command and/or the address of the relay server from the first communication device or the second communication device;
a first route analyzer for obtaining a first routing hop count and a second routing hop count based on the network address of the second client and the address of the address of the relay server, respectively, the first routing hop count being counted from a first client to a second client assuming a direct P2P link therebetween, and the second routing hop being counted from the first client and a relay server assuming a relay channel through the relay server;
a second route analyzer for obtaining a third routing hop count based on the address of the relay server, the third routing hop count being counted from the relay server two the second client assuming the relay channel through the relay server; and
a determination module for comparing a sum of the second routing hop count and the third routing hop count with the first routing hop count, and selecting one of the direct P2P link and the relay channel as a data transmission channel between the first client and the second client based on a result of comparing.

19. The routing system as recited in claim 18, wherein the determination module is further used for selecting a relay transmission channel of the relay method for data transmission if the direct P2P link method is first selected but a direct P2P transmission channel cannot be established.
